(19) United States
(12) Patent Application Publication
(10) Pub. No.: US 2011/0006915 A1
(43) Pub. Date: Jan. 13, 2011

(54) TURN/NO TURN ON RED TRAFFIC LIGHT SIGNAL

(76) Inventor: Charles D. Sower, Birmingham, MI (US)

Correspondence Address: YOUNG BASILE, 3001 WEST BIG BEAVER ROAD, SUITE 624, TROY, MI, 48084, US

(21) Appl. No.: 12/834,140

(22) Filed: Jul. 12, 2010

Related U.S. Application Data
(60) Provisional application No. 61/225,029, filed on Jul. 13, 2009.

(51) Int. Cl. G08G 1/095

(52) U.S. Cl. 340/907

(57) ABSTRACT

Disclosed herein is a traffic light indicator including a base, a circuit board mounted in the base, a light source mounted in the base, the light source is configured to illuminate at least one of a turn on red symbol and a no turn on red symbol and a cover mounted on the base to cover the circuit board and the light source.

### CROSS-REFERENCE TO RELATED APPLICATIONS

This application claims priority to U.S. Provisional Patent Application Ser. No. 61/225,029, filed Jul. 13, 2009, which is hereby incorporated by reference in its entirety.

### BACKGROUND

“Right turn on red” is a principle of law permitting vehicles at a traffic light indicator showing a red signal to turn right at a controlled intersection. At present, many areas permit these right turns after the vehicle makes a full stop and when the driver ensures that the way is clear of traffic and pedestrians. However, at some intersections, a “No Right Turn on Red” traffic sign can be posted that prohibits drivers from making a right turn on a red signal.

Many of these “No Right Turn on Red” traffic signs are placed, for example, a certain distance from the right corner of the intersection. This placement can cause the driver to, for example, overlook reading the sign. Moreover, if the driver has passed the “No Right Turn on Red” sign, fails to read it and desires to make a right turn, he may be unable to know whether such a turn is permissible. In some instances, the driver may also fail to read or see the sign because of darkness, weather conditions or a language barrier.

### SUMMARY

Embodiments of a traffic light indicator are disclosed herein. One such embodiment includes a base, a circuit board, a light source and a cover. The circuit board and light source are mounted in the base. The light source is configured to illuminate at least one of a turn on red symbol and a no turn on red symbol. The cover is mounted on the base to cover the circuit board and the light source.

Embodiments of a traffic light indicator for replacing a conventional “No Right Turn on Red” traffic sign are also disclosed herein. In one such embodiment, the traffic light indicator includes a first section configured to illuminate a green light, a second section configured to illuminate a yellow light and a third section configured to illuminate at least one of a turn on red symbol and a no turn on red symbol.

Other embodiments of the invention are described in additional detail hereinafter.

### BRIEF DESCRIPTION OF THE DRAWINGS

The description herein makes reference to the accompanying drawings wherein like reference numerals refer to like parts throughout the several views, and wherein:

FIG. 1 is a front elevation view of a traffic light indicator including a red-light signal, a yellow-light signal and a green-light signal according to one embodiment of the present invention;

FIG. 2 is an exploded cross sectional view of the red-light signal of the traffic light of FIG. 1;

FIG. 3A is a front elevation view of the red-light signal of FIGS. 1 and 2 in a turn-off operating mode;

FIG. 3B is a front elevation view of the red-light signal of FIGS. 1 and 2 in a no-turn operating mode;

FIG. 3C is a front elevation view of the red-light signal of FIGS. 1 and 2 in a turn-on operating mode;

FIG. 4 is a front elevation view of a red-light signal of a traffic light indicator according to another embodiment of the present invention; and

FIG. 5 is a front elevation view of a traffic light indicator according to another embodiment of the present invention.

### DETAILED DESCRIPTION

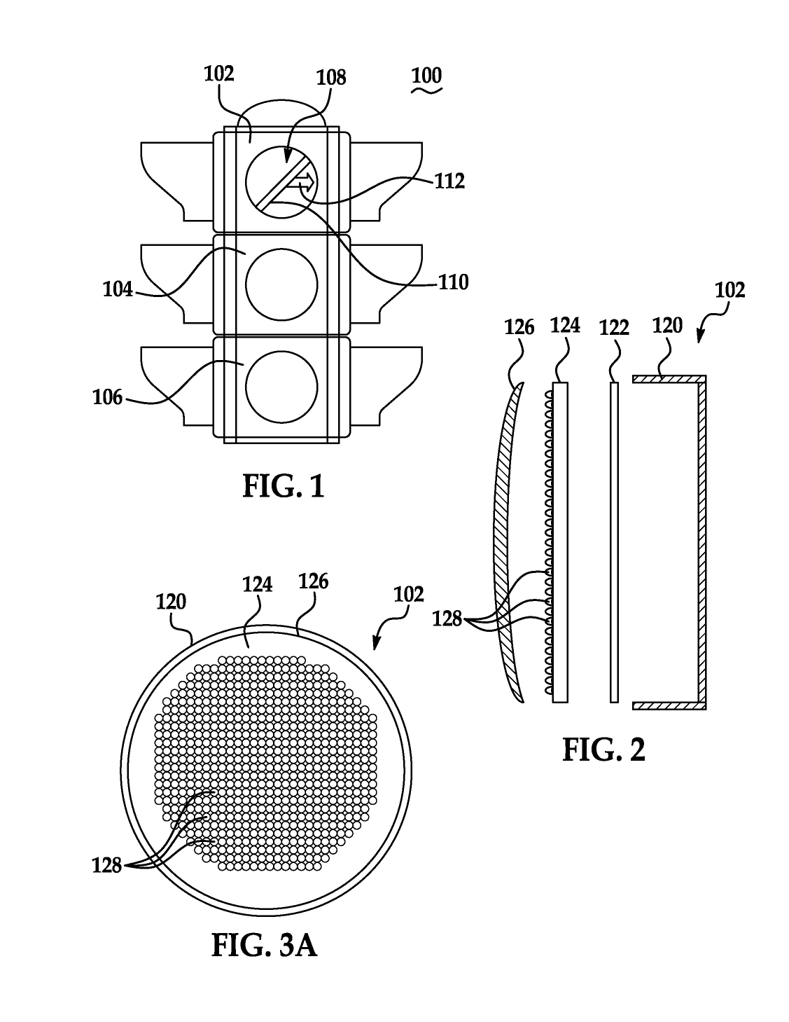

Referring to FIG. 1, a traffic light indicator 100 has three vertically stacked sections according to one embodiment of the present invention. Traffic light indicator includes a top red-light section 102, a center yellow-light section 104 and a lower green-light section 106. In this embodiment, red-light section 102 can be capable of displaying a no turn on red symbol 108 within top red-light section 102. Since no turn on red symbol 108 is a part of red-light section 102 of traffic light indicator 100, conventional “No Right Turn on Red” traffic signs may be unnecessary and may be eliminated. Furthermore, this and other embodiments of the invention, as discussed hereinafter, can eliminate the burden of requiring a driver to find at his peril whether a “No Right Turn on Red” sign has been posted somewhere in the vicinity.

In this embodiment, no turn on red symbol 108 is shown as a “no” symbol 110 overlapping a right arrow 112. Of course, in other embodiments, other symbols may be used such as signs or words For example, in one embodiment, red-light section 102 may contain the phrase “NO TURN ON RED” in lieu of or in addition to no turn on red symbol 108.

Referring to FIG. 2, red-light section includes a base 120, a circuit board 122, a light source 124 and a cover 126. In this embodiment, light source 124 is an LED panel or array and is mounted in base 120 and electrically connects to circuit board 122. Cover 126 can be made of translucent or transparent material and can be mounted to base 120 to protect circuit board 122 and light source 124. In other embodiments, light source 124 can be an incandescent lamp, a halogen lamp, a fluorescent lamp or any other suitable light-emitting device.

Light source 124 can include one or more LEDs 128 of any color, including white. If the LEDs are of a white color, cover 126 can be, for example, a red lens so that light emitted therethrough is of red color. Alternatively, LEDs 128 may be red LEDs. Of course, embodiments of the present invention are not limited to the structure of traffic light 100 shown in FIG. 1 or more specifically, the structure of red-light section 102 shown in FIG. 2. Embodiments of the present invention may be implemented in any suitable structure as desired or required.

Power can be provided to light source 124 through a power supply circuit (not shown) located, for example, on circuit board 122. Accordingly, for example, a power supply circuit can include a rectifier for rectifying AC voltage to obtain DC voltage, a voltage regulator for receiving the DC voltage and outputting a constant voltage to the LEDs and a control unit that determines when to supply power to the LEDs and/or adjust the power supplied, intensity or color of the LEDs. Thus, for example, the control unit may need to adjust the intensity of different LEDs depending on the operation mode of red-light section 102, as will be discussed in more detail below. Of course, depending on the application, power supply circuit will contain different components as desired or required. For example, a rectifier may be unnecessary if the LEDs are to be powered from a DC voltage source. Other power supply circuits are available.

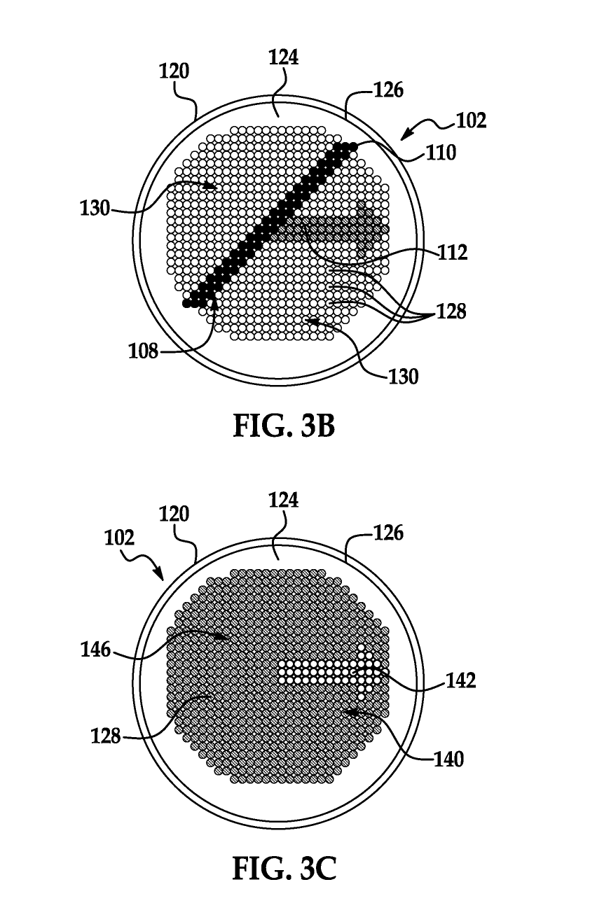

Referring to FIGS. 3A-3C, different operating modes are shown red-light section 102. FIG. 3A illustrates red-light section 102 in a turn-off operating mode. Turn-off operating mode can be selected when, for example, when yellow-light section 104 or green-light section 106 are activated (i.e. the LEDs located therein are turned on). Specifically, no LEDs are lighted in red-light section 102 in the turn-off operating mode.

FIG. 3B illustrates red-light section 102 in a no-turn operating mode. No-turn operating mode can be selected when, for example, it is desired that no right turns are made on a red light. Accordingly, no turn on red symbol 108 can be displayed by, for example, lighting a pattern of LEDs on light source 124. Specifically, a pattern of LEDs can be lighted that illustrate right arrow 112. The right arrow pattern of LEDs can be programmed within the control unit and furthermore, the control unit can light these LEDs at a different intensity, color, color temperature or other light characteristic so that the driver can recognize and distinguish them from the other LEDs. Likewise, a pattern of LEDs can be lighted that illustrate “no” symbol 110. The pattern pertaining to the “no” symbol can also be programmed within the control unit and furthermore, the control unit can also light these LEDs at a different intensity, color, color temperature or other light characteristic so that the driver can recognize and distinguish them from the other LEDs. The remaining LEDs in region 130 signify a red light indication to tell the driver to “stop” and can be illuminated at a different intensity, color, color temperature or other light characteristic than right arrow 112 and “no” symbol 110. Thus, for example, region 130 can be lighted at a low intensity, “no” symbol 110 can be lighted at a greater intensity than region 130 and right arrow 112 can be lighted at even a greater intensity than both region 130 and “no” symbol 110. Of course, other lighting configurations and symbols are also possible.

FIG. 3C illustrates red-light section 102 in a turn-on operating mode. Turn-on operating mode can be selected when, for example, it is permissible to make right turns on a red light and when there should be a red light indication on traffic light indicator 100. Accordingly, a turn on red symbol 140 can be displayed by, for example, lighting a pattern of LEDs on light source 124. Specifically, a pattern of LEDs can be lighted that illustrate a right arrow 142. In one embodiment, right arrow 142 can be flashing according to a prescribed time period (e.g. one second). In another embodiment, the right arrow pattern of LEDs can remain lighted. The right arrow pattern of LEDs can be programmed within the control unit and furthermore, the control unit can light these LEDs at a different intensity, color, color temperature or other light characteristic so that the driver can recognize and distinguish them from the other LEDs. The remaining LEDs in region 146 signify a red light indication to tell the driver to “stop” and can be illuminated at a different intensity, color, color temperature or other light characteristic than right arrow 142. Thus, for example, region 146 can be lighted at a high intensity and right arrow 142 can be lighted at a lower intensity than region 146. Of course, other lighting configurations and symbols are also possible.

In another embodiment (not shown), turn-on operating mode can be illustrated by having all LEDs 128 of light source 124 illuminated at, for example, the same intensity, color and color temperature. Further, in another embodiment, no turn on red symbol 108 may always be illuminated regardless of whether there is a red-light indication, a turn-on operating mode or any other factor.

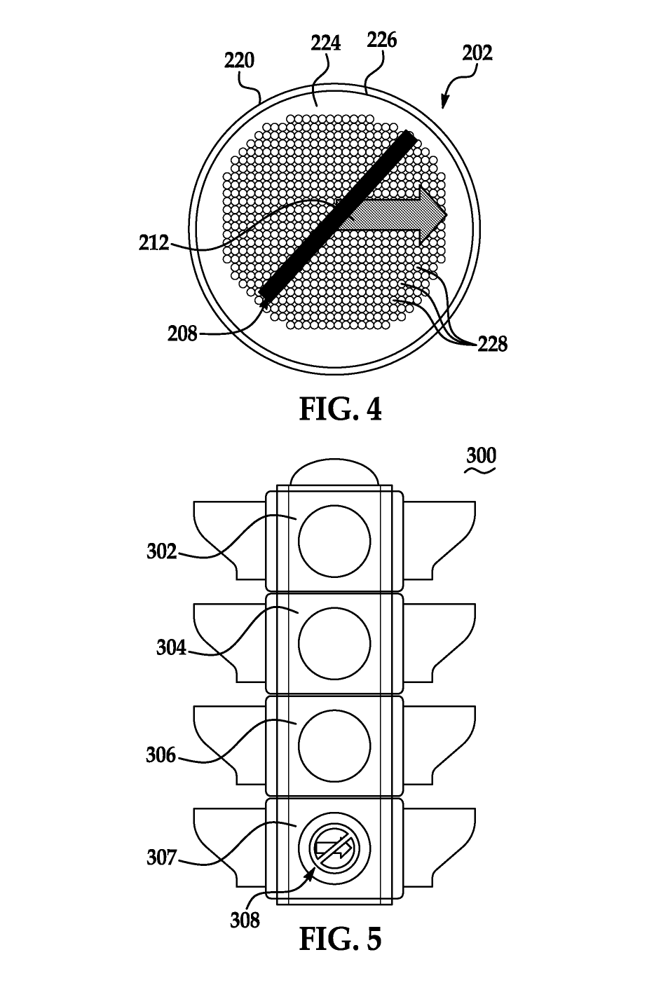

FIG. 4 illustrates a red-light section 202 according to another embodiment of the present invention. In this embodiment, similar to the embodiment discussed previously, red-light section 202 is capable of displaying a no turn on red symbol 208 within top red-light section 202. Further, red-light section includes a base 220, a circuit board (not shown), a light source 224 including LEDs 228 and a cover 226. However, in this embodiment, cover 226 includes a sign portion 250 that includes both a “no” symbol portion and a right arrow portion 212, all of which can be made of translucent or transparent material. When, for example, LEDs 228 generate light, sign portion 250 is highlighted on cover 226. Sign portion 250 is preferably a different color than cover 226 so that the driver can recognize that there right turns on red lights are not permitted. In other embodiments, light source 124 can be an incandescent lamp, a halogen lamp, a fluorescent lamp or any other suitable light-emitting device that can highlight sign portion.

However, in this embodiment, no turn on red symbol 108 is shown as a “no” symbol 210 overlapping a right arrow 212. Of course, in other embodiments, other symbols, signs or words may be used. For example, in one embodiment, sign portion 250 may contain the phrase “NO TURN ON RED” in lieu of or in addition to no turn on red symbol 208.

FIG. 5 illustrates a traffic light indicator 300 according to another embodiment of the present invention. Traffic light indicator has four vertically stacked and includes a red-light section 302, a yellow-light section 304, a green-light section 306 and a no turn on red section 308. In this embodiment, no turn on red section 307 is capable of displaying a no turn on red symbol 308 therein. Thus, red-light section 302 and no turn on red section 307 are separate structures within traffic light indicator 300.

While the embodiments have referred to “no turn on red” symbols, sections etc., it is to be understand that the embodiments may include “turn on red” symbols, sections, etc. in lieu of or in addition thereto.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed:

1. A traffic light indicator, comprising:
a base;
a circuit board mounted in the base;
a light source mounted in the base, the light source configured to illuminate at least one of a turn on red symbol and a no turn on red symbol; and
a cover mounted on the base to cover the circuit board and the light source.

2. The traffic light indicator of claim 1, wherein the no turn on red symbol is in the form of a “no” symbol overlapping a right arrow.

3. The traffic light indicator of claim 2, wherein the light source is configured to illuminate the “no” symbol and the right arrow.

4. The traffic light indicator of claim 1, wherein the light source is a plurality of LEDs.

5. The traffic light indicator of claim 4, wherein the at least one some of the plurality of LEDs are illuminated at at least one of a different intensity, a different color and a different color temperature.

6. The traffic light indicator of claim 1, further comprising:
a power supply configured to supply power to the light source.

7. The traffic light indicator of claim 1, wherein the light source is at least one of LEDs, an incandescent bulb, a halogen lamp and a fluorescent lamp.

8. The traffic light indicator of claim 1, wherein at least one of the turn on red symbol and the no turn on red symbol are displayed as messages.

9. A traffic light indicator for replacing a conventional “No Right Turn on Red” traffic sign, comprising:
a first section configured to illuminate a green light;
a second section configured to illuminate a yellow light; and
a third section configured to illuminate at least one of a turn on red symbol and a no turn on red symbol;

10. The traffic light indicator of claim 9, further comprising:
a fourth section configured to illuminate a red light, the fourth section separate from the third section.

11. The traffic light indicator of claim 9, wherein the no turn on red symbol is in the form of a “no” symbol overlapping a right arrow.

12. The traffic light indicator of claim 9, wherein the light source is configured to illuminate the “no” symbol and the right arrow.

13. The traffic light indicator of claim 9, wherein the third section includes:
a base;
a circuit board mounted in the base;
a light source mounted in the base, the light source configured to illuminate the at least one of turn on red symbol and no turn on red symbol; and
a cover mounted on the base to cover the circuit board and the light source.

14. The traffic light indicator of claim 13, wherein the light source is a plurality of LEDs.

15. The traffic light indicator of claim 14, wherein the at least one some of the plurality of LEDs are illuminated at at least one of a different intensity, a different color and a different color temperature.

16. The traffic light indicator of claim 13, further comprising:
a power supply configured to supply power to the light source.

17. The traffic light indicator of claim 13, wherein the light source is at least one of LEDs, an incandescent bulb, a halogen lamp and a fluorescent lamp.

18. The traffic light indicator of claim 13, wherein at least one of the turn on red symbol and the no turn on red symbol are displayed as messages.

19. The traffic light indicator of claim 13, wherein the cover includes a translucent or transparent sign portion, the sign portion including the at least one of turn on red symbol and no turn on red symbol.

20. The traffic light indicator of claim 19, wherein light from the light source is adapted to illuminate the at least one of turn on red symbol and no turn on red symbol.
